(19) United States
(12) Patent Application Publication
(10) Pub. No.: US 2026/0350819 A1
(43) Pub. Date: Nov. 5, 2026

(54) IMAGE PROCESSING APPARATUS AND METHOD, IMAGE CAPTURING APPARATUS, IMAGE CAPTURING SYSTEM, AND STORAGE MEDIUM

(71) Applicant: CANON KABUSHIKI KAISHA, Tokyo (JP)

(72) Inventors: TOMOHIRO NISHIYAMA, Tokyo (JP); YUKI YOSHIMURA, Tokyo (JP)

(21) Appl. No.: 19/653,738

(22) Filed: Apr. 21, 2026

(30) Foreign Application Priority Data
May 1, 2025 (JP) 2025-076379

(51) Int. Cl. G06T 7/292; G06T 7/246; G06T 7/55; H04N 23/61; H04N 23/69; H04N 23/90

(52) U.S. Cl. CPC G06T 7/292; G06T 7/246; G06T 7/55; H04N 23/61; H04N 23/69; H04N 23/90; G06T 2207/30196; G06T 2207/30224

(57) ABSTRACT

An image processing apparatus comprises: a first determination unit that detects, from a first image, first subject or subjects having predetermined characteristics, and determines one of the detected first subjects as a main subject; a detection unit that detects, from the first image, second subject or subjects having predetermined different characteristics; a second determination unit that determines first and second weights to be applied to a first position of the main subject and a second position based on a position or positions of the second subject or subjects, respectively, on the basis of a distance between the first and second positions; a third determination unit that obtains a third position based on the first and second weights, and the first and second positions; and a control unit that controls acquisition of a second image based on the third position.

### BACKGROUND

### Field of the Technology

The present disclosure relates to an image processing apparatus and method, an image capturing apparatus, an image capturing system, and a storage medium, and more particularly to a technique for tracking a subject in moving image shooting.

### Description of the Related Art

In recent years, technology for automatically tracking a region of interest that viewers are interested in or that users want to capture has become increasingly important in the broadcasting and moving image capturing of sports and events, and in personal video distribution. This automatic tracking technology can be used, for example, when cropping a region of interest within an image for broadcasting or distribution, or when automatically controlling the camera's attitude for broadcasting, distribution, or image capturing. Japanese Patent Laid-Open No. 2020-170892 discloses a technology for adjusting the moving amount of an automatic tracking camera based on factors (e.g., a goal in soccer, an opposing player, etc.) that affect the moving amount of the target to be tracked in situations that change over time.

However, the method of Japanese Patent Laid-Open No. 2020-170892 cannot handle a situation in which the subject to be tracked itself changes, for example, when the ball is passed.

### SUMMARY

The present disclosure has been made in consideration of the above situation, and in a case of shooting a moving image of a scene including a plurality of moving subjects, the area to be shot is determined with high accuracy and robustness.

According to the present disclosure, provided is an image processing apparatus comprising one or more processors and/or circuitry which function as: a first determination unit that detects, from a first image, one or more first subjects having predetermined characteristics, and determines one of the detected first subjects as a main subject; a detection unit that detects, from the first image, one or more second subjects having predetermined characteristics different from those of the detected first subjects; a second determination unit that determines a first weight to be applied to a first position of the main subject, and a second weight to be applied to a second position based on a position or positions of the second subject or subject, on the basis of a distance between the first position and the second position; a third determination unit that obtains a third position based on the first weight and the second weight, and the first position and the second position; and a control unit that controls acquisition of a second image based on the third position.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating an exemplary configuration of an image processing apparatus according to a first embodiment of the present disclosure.

FIG. 2 is a flowchart illustrating an overall flow of image processing according to the first embodiment.

FIGS. 3A and 3B are conceptual diagrams illustrating a specific example of processing by a quasi-subject detection unit and a tracking coordinate determination unit according to the first embodiment.

FIG. 4 is a conceptual diagram illustrating an example of changes in weight over time according to the first embodiment.

FIG. 5 is a block diagram illustrating an exemplary configuration of an image capturing system according to a second embodiment.

FIG. 6 is a conceptual diagram explaining an arrangement of a plurality of image capturing units according to the second embodiment.

FIGS. 7A and 7B are conceptual diagrams illustrating a specific example of processing by the quasi-subject detection unit and the tracking coordinate determination unit according to the second embodiment.

FIG. 8 is a block diagram illustrating an exemplary configuration of an image capturing system according to a third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

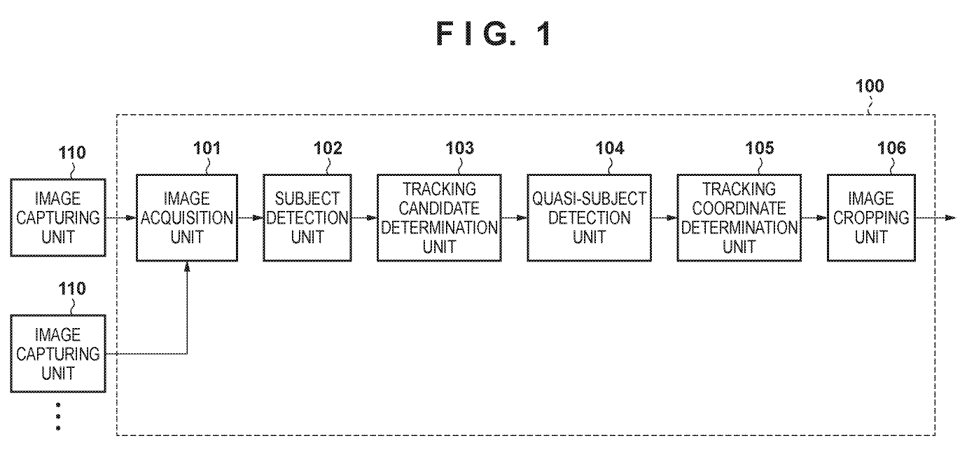

A configuration of an image processing apparatus according to this embodiment is described with reference to FIG. 1.

In this embodiment, images are captured using a plurality of image capturing apparatuses, and the captured images are processed by an image processing apparatus external to the image capturing apparatuses. Note that this embodiment may use a single image capturing apparatus instead of a plurality of apparatuses, or the image processing apparatus may be built into the image capturing apparatus.

FIG. 1 is a block diagram illustrating an exemplary configuration of an image processing apparatus 100 according to a first embodiment of the present disclosure. The image processing apparatus 100 includes an image acquisition unit 101 that acquires image data from image capturing units 110, a subject detection unit 102, a tracking candidate determination unit 103, a quasi-subject detection unit 104, a tracking coordinate determination unit 105, and an image cropping unit 106. Here, a subject refers to a subject (hereinafter referred to as a "first subject") that can be a tracking candidate (main subject) in an expected scene, such as a person, an animal, or a vehicle. Here, a person is taken as an example. A quasi-subject refers to a second subject other than the first subject or a characteristic feature. For example, a tool specific to the scene or, in the case where a plurality of first subjects exists, the quasi-subject refers to the representative coordinates (e.g., center of gravity) of the first subjects. In the following description, a sports scene is used as an example, and the quasi-subject refers to a ball or the center of gravity of the first subjects. In addition to sports, quasi-subjects can also be, for example, cooking utensils or products when streaming video of a cooking scene or a product introduction scene, but are not limited thereto.

The image capturing units 110 may be digital cameras, smartphones, surveillance cameras, or the like, and may capture image information of a target subject. However, the devices are not limited to these, as long as they are capable of capturing image information. In this embodiment, the image capturing units 110 are fixedly installed, and partial areas of the captured images are cropped around the coordinates calculated by the tracking coordinate determination unit 105.

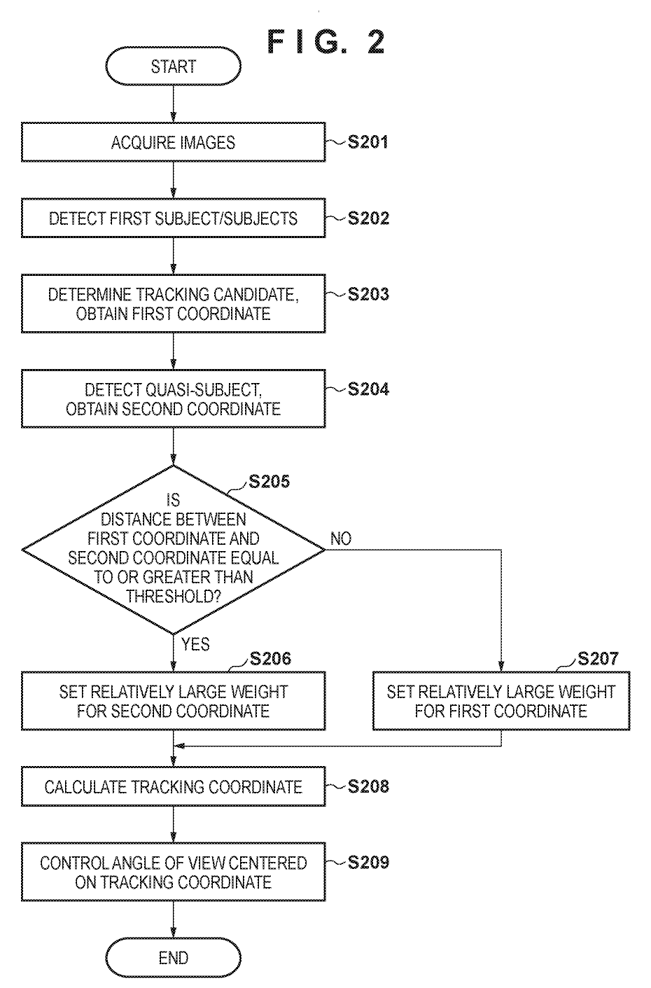

Next, the overall flow of image processing in the first embodiment by the image processing apparatus 100 will be described with reference to the flowchart in FIG. 2.

First, in step S201 in FIG. 2, the image acquisition unit 101 acquires images from the image capturing units 110. In step S202, the subject detection unit 102 detects the first subject or subjects in the images acquired by the image acquisition unit 101. As a method for detecting the first subject, for example, existing deep learning networks such as Convolutional Neural Network (CNN) and Transformer can be used. In addition to deep learning, rule-based detection methods using feature amounts can also be used. Any other method that can detect the first subject may be used.

In step S203, the tracking candidate determination unit 103 determines a tracking candidate (main subject) from among the first subject or subjects detected in step S202, and sets the coordinates of the determined subject as a first coordinate x1. The tracking candidate may be determined by applying a known tracking process to chronologically identify the same subject as the tracking candidate, or by detecting a first subject performing a characteristic action and identifying that first subject as the tracking candidate (main subject). For example, in a sports scene, a known behavior-recognition neural network can be used to select, as a tracking candidate, the subject in the captured image whose movement is most likely to correspond to that of a main player. Alternatively, the same first subject may be identified in images obtained from the plurality of image capturing units 110, and the information on the identified first subject may be integrated to determine the tracking candidate. This enables robust determination of the tracking candidate even in a case where the subject is occluded from a specific image capturing unit 110 or in a case where only the back of the subject's head is visible from the image capturing unit 110. In this embodiment, the coordinate x represents the two-dimensional pixel coordinates on the image.

In step S204, the quasi-subject detection unit 104 detects a quasi-subject and sets it as a second coordinate x2. Details of the quasi-subject detection method will be described later. Here, it is assumed that an object specific to the scene (here, a ball) is detected based on the image information from the image capturing unit 110 using an existing method such as deep learning, as described in the explanation for detecting the first subject.

In step S205, the tracking coordinate determination unit 105 determines whether the distance between the first coordinate x1 and the second coordinate x2 is equal to or greater than a predetermined threshold Th. If the distance between the first coordinate x1 and the second coordinate x2 is equal to or greater than the threshold Th, in step S206, the tracking coordinate determination unit 105 sets the weight w2 for the second coordinate x2 to be relatively greater than the weight w1 for the first coordinate x1. Here, the sum of the weights w1 and w2 satisfies, for example, w1 + w2 = 1. On the other hand, if the distance between the first coordinate x1 and the second coordinate x2 is less than the threshold Th in step S205, the tracking coordinate determination unit 105 sets the weight w1 for the first coordinate x1 to be relatively greater than the weight w2 for the second coordinate x2 in step S207.

In step S208, the tracking coordinate determination unit 105 performs weighted addition (xt = w1×x1 + w2×x2) using the weights w1 and w2 to determine a tracking coordinate xt. Then, in step S209, the image cropping unit 106 crops the image centered on the tracking coordinate xt, and then the processing is ended. The cropped image size may be fixed or may be changed depending on the content of the scene. While the tracking coordinate xt has been described as being centered, it does not necessarily have to be the center and may be set at any position within the cropping area depending on the scene being captured. Furthermore, the tracking coordinate xt may be determined by a calculation other than weighted addition, as long as the first coordinate x1 is preferentially reflected in the tracking coordinate xt when the weight w1 is greater than the weight w2, and the second coordinate is preferentially reflected in the tracking coordinate xt when the weight w2 is greater than the weight w1.

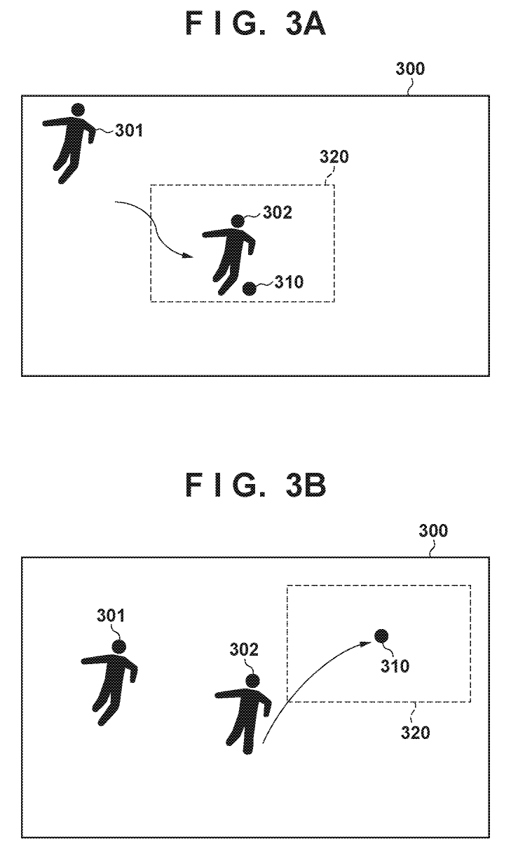

Next, a specific example of the processing by the quasi-subject detection unit 104 and the tracking coordinate determination unit 105 will be described with reference to FIGS. 3A and 3B.

In FIGS. 3A and 3B, a reference numeral 300 denotes captured images, reference numerals 301 and 302 denote first subjects, with first subject 302 representing the tracking candidate. A reference numeral 310 denotes a quasi-subject, which is the ball in this example. A reference numeral 320 denotes crop regions set by image cropping unit 106 with the tracking coordinate at its center. Note that for convenience of illustration, in FIGS. 3A and 3B, the frame indicating crop regions 320 are highlighted in the images 300. In reality, the images 300 are wide-angle images, and the proportion of crop regions 320 is often smaller than that shown in FIGS. 3A and 3B. For example, the images 300 are captured so that the entire court is included.

FIG. 3A shows a case where the distance between the tracking candidate 302 and the quasi-subject 310 is less than the threshold Th, and the value of the weight w1 is set larger than the weight w2. Here, if w1 = 1, w2 = 0, the first coordinate x1 is the center of gravity of the tracking candidate 302, and the second coordinate x2 is the center of gravity of the quasi-subject 310, then the tracking coordinate xt is x1.

FIG. 3B shows a case where the distance between the tracking candidate 302 and the quasi-subject 310 is equal to or greater than the threshold Th, and the value of the weight w2 is set to be larger than the weight w1. Here, if w1 = 0 and w2 = 1, then the tracking coordinate xt is x2.

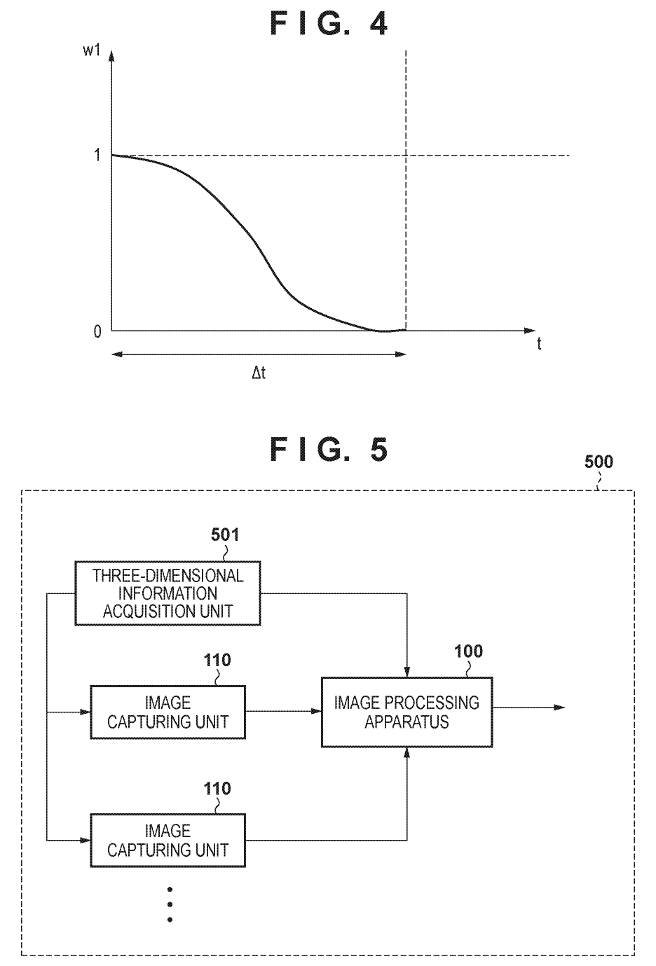

In the above description, an example has been described in which the weights are immediately switched between 0 and 1 depending on the determination between the distance and the threshold value Th. Below, a case in which the weights are gradually changed over time will be described with reference to FIG. 4.

FIG. 4 is a conceptual diagram showing how the weight is changed over time in a case where the distance between the tracking candidate and the quasi-subject becomes equal to or greater than the threshold Th. The horizontal axis plots time, and the vertical axis plots the value of the weight w1. If the time when the distance between the tracking candidate and the quasi-subject becomes equal to or greater than the threshold Th is set to t = 0, the weight w1 is 1 at t = 0, and the weight w1 is attenuated to 0 over time Δt. This prevents abrupt changes in the tracking coordinate. Furthermore, instead of switching the weights based on the comparison result between the distance and the threshold, the weights may be a function of the distance between the tracking candidate and the quasi-subject. The function may be stored as a table, or may be determined using a learned network. In this case, smoothing the weights over time can also prevent abrupt changes in the tracking coordinate.

As described above, by determining the tracking coordinate based on the distance between the tracking candidate and the quasi-subject, tracking can be performed with high accuracy and robustness even when the area of interest switches due to pass of a ball or the like. Note that, although the present embodiment has been described using a sports scene as an example, the present disclosure is not limited to this. For example, the present disclosure can be applied to a case where an object (quasi-subject) moves between a plurality of first subjects, such as when person A hands cooking utensils to person B in a cooking scene, and the main subject changes from person A to person B.

### Second Embodiment

Next, a second embodiment will be described.

In the second embodiment, an example will be described in which the three-dimensional coordinates of the first subject and quasi-subject are acquired to determine the tracking coordinate. Note that a description of the same components as those in the first embodiment will be omitted, and the following description will focus on the differences from the first embodiment.

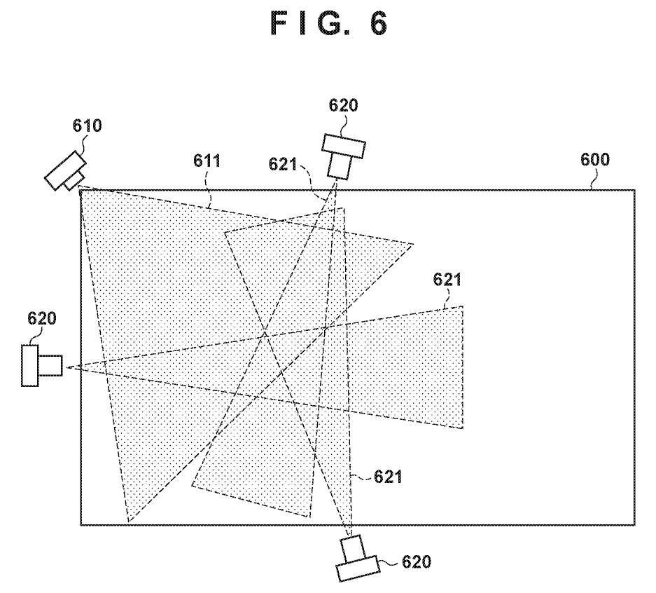

FIG. 5 is a block diagram illustrating an example of a configuration of an image capturing system 500 according to the second embodiment of the present disclosure. The image capturing system 500 includes a three-dimensional information acquisition unit 501 in addition to the image capturing units 110 and the image processing apparatus 100 shown in FIG. 1.

The three-dimensional information acquisition unit 501 acquires the three-dimensional coordinates of the first subject and the quasi-subject. Note that, although the three-dimensional information acquisition unit 501 outputs the three-dimensional information to all the image capturing units 110 in FIG. 5, it may output the information to only some of the image capturing units 110.

The three-dimensional information acquisition unit 501 is, for example, a LiDAR sensor, and measures the three-dimensional shape of the object. The LiDAR sensor has a light beam output unit that outputs laser light and irradiates the surface of the object with the light beam, and a receiving unit that receives the light beam reflected from the surface of the object. The distance to the surface of the structure in the irradiation direction is calculated using the time it takes for the reflected light beam to return or the phase difference between the irradiated light beam and the reflected light beam, and the three-dimensional position is acquired based on the calculated distance and information on the irradiation direction. However, the three-dimensional information acquisition unit 501 is not limited to a LiDAR sensor and may be, for example, a device that measures distance using electromagnetic waves, sound waves, or the like other than laser beam. Furthermore, if the relative positional relationship between the image capturing units 110 that are located apart is known, the correspondence between identical feature points in each image may be determined and the distance to the object may be calculated using a triangulation technique. In this case, image information of images simultaneously captured by the image capturing units 110 is input to the three-dimensional information acquisition unit 501, which calculates three-dimensional positions based on the image information.

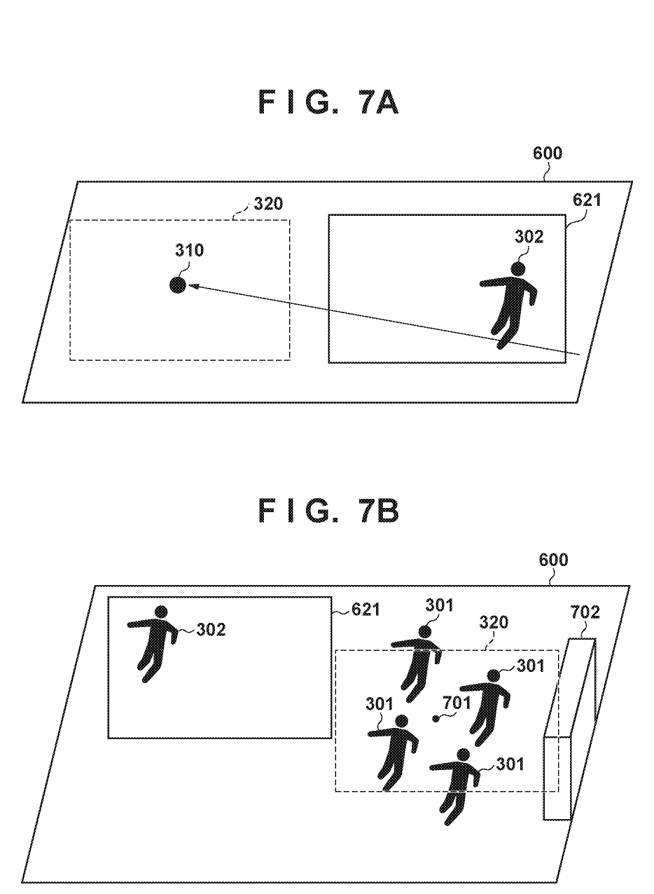

An example of the arrangement of the image capturing units 110 in this embodiment is shown in FIG. 6. In FIG. 6, a reference numeral 600 denotes a sports field (scene), an image capturing unit 610 is a wide-angle image capturing unit, a reference numeral 611 denotes an angle of view range corresponding to an image capturing unit 610, image capturing units 620 are telephoto image capturing units, and a reference numeral 621 denotes angle of view ranges (telephoto angle of view) corresponding to the image capturing units 620. The image capturing units 610 and 620 are fixedly installed. A specific example of the processing by the quasi-subject detection unit 104 and tracking coordinate determination unit 105 in this embodiment will now be described using FIGS. 7A and 7B. The image processing flow is similar to that shown in the flowchart of FIG. 2, and therefore FIG. 2 will be referenced as appropriate.

FIG. 7A illustrates a case where the quasi-subject 310 has moved outside the telephoto angle of view 621. In step S204, the quasi-subject detection unit 104 acquires the three-dimensional coordinate x2 of the quasi-subject from the three-dimensional information acquisition unit 501. The determination in step S205 is performed using the distance in three-dimensional space. If any of the telephoto image capturing units 620 is capturing an image of the crop region 320, the image cropping unit 106 selects the image captured by that telephoto image capturing unit 620. On the other hand, if none of the telephoto image capturing units 620 is capturing an image of the crop region 320, the image cropping unit 106 crops the image region of an image, that corresponds to the crop region 320, captured by the wide-angle image capturing unit 610. In this way, if a high-resolution image is available, selecting that image can improve the quality of the video.

FIG. 7B is a conceptual diagram illustrating a case where a quasi-subject is the center of gravity of subjects. In FIG. 7B, a reference numeral 701 represents the center of gravity of the first subjects 301, and a reference numeral 702 represents a goal. If the first subject 302 is mistakenly determined to be a tracking candidate due to a feint move or the like, by checking whether the distance between the quasi-subject 310 (center of gravity 701) and tracking candidate 302 is greater than or equal to the threshold Th, as shown in FIGS. 7A and 7B, it becomes possible to switch the target to be tracked to the quasi-subject and track the area that is the center of play.

Note that tracking the three-dimensional coordinate of the ball 310 itself would result in vertical fluctuations in the image extracted by the image cropping unit 106. To address this issue, the tracking coordinate determination unit 105 may determine the tracking coordinate based only on (x, y) of the calculated three-dimensional coordinates (x, y, z). Here, z is the vertical coordinate axis. Additionally, near the goal 702, scenes centered around people, such as shooting scenes, are often the ones that are most likely to be broadcast and filmed. On the other hand, corner kicks require quick tracking of the quasi-subject. Therefore, the tracking coordinate determination unit 105 may change the method for determining the weights w1 and w2 depending on the coordinates of the tracking candidate and the quasi-subject on the field 600. For example, near the goal 702, the threshold Th for the distance between the tracking candidate and the quasi-subject is increased to prevent the weight w2 from increasing, while the threshold Th is decreased to facilitate a large weight w2 in the case of a corner kick. Other than adjusting the threshold value Th, other methods may be employed, such as changing the form of the function of the weight with respect to the distance.

As described above, according to the second embodiment, by utilizing the three-dimensional positions of the first subjects and quasi-subject, it is possible to deal with feint moves and erroneous determination of the tracking candidate, and to track and capture the main area in the scene more robustly and with higher accuracy.

### Third Embodiment

Next, a third embodiment of the present disclosure will be explained.

In this embodiment, instead of cropping images using the image cropping unit 106, a case in which images are captured using pan/tilt control of the image capturing units 110 using a control unit such as a camera platform will be explained. Note that explanations of components that are the same as those in the first and second embodiments will be omitted, and instead the differences from the first and second embodiments will be mainly explained.

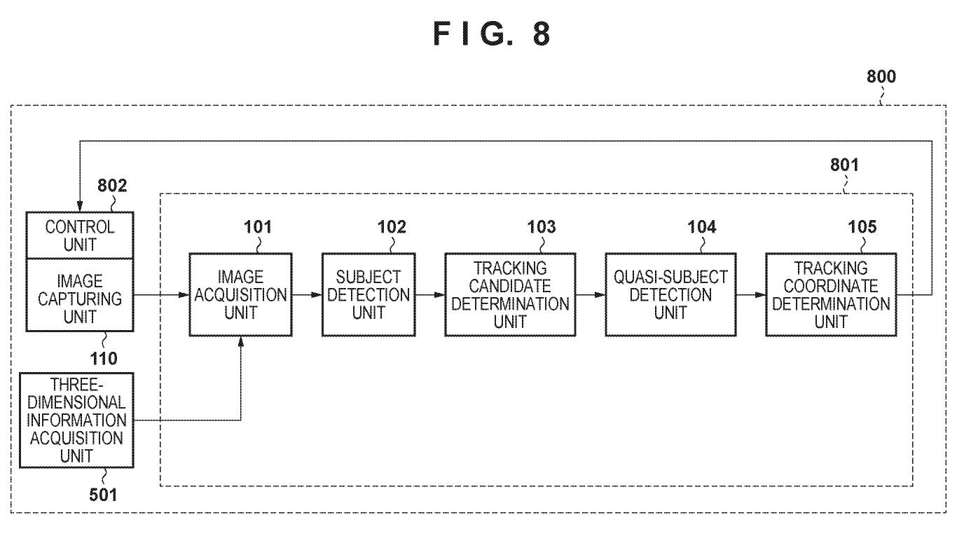

FIG. 8 is a block diagram illustrating an example of the configuration of an image capturing system 800 according to the third embodiment of the present disclosure. Note that the same reference numerals are used to designate the same components as those shown in FIGS. 1 and 5, and descriptions thereof will be omitted.

An image processing apparatus 801 determines tracking coordinate based on captured image information and three-dimensional position information using a method similar to that of the second embodiment. A control unit 802, which is, for example, a camera platform, controls the orientation of the image capturing unit 110 based on the tracking coordinate determined by the image processing apparatus 801. While FIG. 8 illustrates an example in which one image capturing unit 110 is used, a plurality of image capturing units 110 may be used, and the control unit 802 may be provided for each image capturing unit 110, or may be provided for only a specific image capturing unit 110. Further, the three-dimensional information acquisition unit 501 may not be included. In that case, the tracking coordinate is determined using the process described in the first embodiment. The weights may be determined based on the physical characteristics of the control unit 802. For example, in FIG. 4, a long period Δt is set for switching the weights over time for a control unit 802 with low tracking ability, while a short period Δt is set for a control unit 802 with high tracking ability. Any other method may be used as long as the weights can be determined in accordance with the characteristics of the control unit 802.

As described above, according to the third embodiment, it is possible to automatically track the region of interest robustly and with high precision by pan/tilt control of the camera.

### Other Embodiments

The present disclosure may be applied to a system consisting of a plurality of devices, or to a device consisting of a single device.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No.2025-076379, filed May 1, 2025 which is hereby incorporated by reference herein in its entirety.

What is claimed is:

1. An image processing apparatus comprising one or more processors and/or circuitry which function as:
a first determination unit that detects, from a first image, one or more first subjects having predetermined characteristics, and determines one of the detected first subjects as a main subject;
a detection unit that detects, from the first image, one or more second subjects having predetermined characteristics different from those of the detected first subjects;
a second determination unit that determines a first weight to be applied to a first position of the main subject, and a second weight to be applied to a second position based on a position or positions of the second subject or subject, on the basis of a distance between the first position and the second position;
a third determination unit that obtains a third position based on the first weight and the second weight, and the first position and the second position; and
a control unit that controls acquisition of a second image based on the third position.

2. The image processing apparatus according to claim 1, wherein a sum of the first weight and the second weight is a predetermined value.

3. The image processing apparatus according to claim 2, wherein the second determination unit compares the distance with a predetermined threshold, to make the first weight greater than the second weight in a case where the distance is less than the threshold, and to make the first weight smaller than the second weight in a case where the distance is equal to or greater than the threshold.

4. The image processing apparatus according to claim 2, wherein the second determination unit compares the distance with a predetermined threshold, and makes the first weight greater than the second weight in a case where the distance is less than the threshold, and, in a case where the distance changes from being less than the threshold to being equal to or greater than the threshold, gradually decreases the first weight and gradually increases the second weight.

5. The image processing apparatus according to claim 2, wherein the second determination unit makes the first weight greater in a case where the distance is a first distance than in a case where the distance is a second distance longer than the first distance.

6. The image processing apparatus according to claim 2, wherein the second determination unit changes a method for determining the first weight and the second weight in accordance with the first position and the second position in a scene in which the first image was captured.

7. The image processing apparatus according to claim 1, wherein
a plurality of the first image obtained by simultaneously capturing a same scene with a plurality of image capturing apparatuses are acquired, and
the first determination unit detects a same subject as the first subject in the plurality of the first image.

8. The image processing apparatus according to claim 1, wherein the one or more processors and/or circuitry further function as an acquisition unit that acquires the first position and the second position,
wherein the first position and the second position are positions in the first image.

9. The image processing apparatus according to claim 1, wherein the one or more processors and/or circuitry further function as an acquisition unit that acquires the first position and the second position,
wherein the first position and the second position are three-dimensional positions in a scene in which the first image was captured.

10. The image processing apparatus according to claim 7, wherein the one or more processors and/or circuitry further function as:
an input unit that inputs information including positions of the plurality of image capturing apparatuses; and
an acquisition unit that acquires three-dimensional positions of the first position and the second position in a scene in which the plurality of the first image were captured, based on positions of the first subject or subjects and the second subject or subjects in each of the plurality of the first image and the information on positions of the plurality of image capturing apparatuses.

11. The image processing apparatus according to claim 9, wherein the third determination unit does not use information on height-direction position in the second position.

12. The image processing apparatus according to claim 1, wherein, in a case where a plurality of the second subjects are detected, a position of a center of gravity of the plurality of the second subjects is acquired as the second position.

13. The image processing apparatus according to claim 1, wherein the control unit crops, from the first image, an image within a predetermined range centered on the third position as the second image.

14. The image processing apparatus according to claim 1, wherein
a plurality of the first image obtained by simultaneously capturing a same scene with a plurality of image capturing apparatuses are acquired, the plurality of image capturing apparatuses capturing images having mutually different angles of view, and
the control unit selects, from among the plurality of the first image, a first image having a narrowest angle of view that includes an image within a predetermined range centered on the third position, and crops an image of the range from the selected first image as the second image.

15. The image processing apparatus according to claim 1, wherein the control unit controls an image capturing apparatus that captures an image so as to capture an image including the third position.

16. The image processing apparatus according to claim 1, wherein the first subject is a person, a vehicle, or an animal.

17. The image processing apparatus according to claim 1, wherein the second subject or subjects is/are an object or objects unique to a scene in which the first image was captured.

18. The image processing apparatus according to claim 1, wherein the first determination unit determines the main subject based on at least one of temporal information of a position of the first subject, and a position, a size, and an attitude of the first subject in the first image.

19. The image processing apparatus according to claim 1, wherein the third determination unit obtains the third position by performing a weighted addition of the first position and the second position using the first weight and the second weight.

20. An image capturing apparatus comprising:
the image processing apparatus according to claim 1; and
an image capturing unit that captures an image.

21. An image capturing system comprising:
the image processing apparatus according to claim 1; and
an image capturing apparatus that captures an image.

22. The image capturing system according to claim 21, further comprising an acquisition apparatus that acquires a distance to a subject in a scene captured by the image capturing apparatus.

23. An image processing method comprising:
detecting, from a first image, one or more first subjects having predetermined characteristics, and determining one of the detected first subjects as a main subject;
detecting, from the first image, one or more second subjects having predetermined characteristics different from those of the detected first subjects;
determining a first weight to be applied to a first position of the main subject, and a second weight to be applied to a second position based on a position or positions of the second subject or subjects, on the basis of a distance between the first position and the second position;
obtaining a third position based on the first weight and the second weight, and the first position and the second position; and
controlling acquisition of a second image based on the third position.

24. A non-transitory computer-readable storage medium, the storage medium storing a program that is executable by the computer, wherein the program includes program code for causing the computer to function as an image processing apparatus comprising:
a first determination unit that detects, from a first image, one or more first subjects having predetermined characteristics, and determines one of the detected first subjects as a main subject;
a detection unit that detects, from the first image, one or more second subjects having predetermined characteristics different from those of the detected first subject;
a second determination unit that determines a first weight to be applied to a first position of the main subject, and a second weight to be applied to a second position based on a position or positions of the second subject or subjects, on the basis of a distance between the first position and the second position;
a third determination unit that obtains a third position based on the first weight and the second weight, and the first position and the second position; and
a control unit that controls acquisition of a second image based on the third position.
